(19) United States
(12) Patent Application Publication
(10) Pub. No.: US 2026/0186676 A1
(43) Pub. Date: Jul. 2, 2026

(54) ELECTRONIC DEVICE AND METHOD FOR MANAGING MEMORY

(71) Applicant: MEDIATEK INC., Hsinchu City (TW)

(72) Inventors: Chin-Wen CHANG, Hsinchu City (TW); Ciao-Siang SIAO, Hsinchu City (TW); Chung-Jung LEE, Hsinchu City (TW); Wei-Gen WU, Hsinchu City (TW)

(21) Appl. No.: 19/387,979

(22) Filed: Nov. 13, 2025

Related U.S. Application Data
(60) Provisional application No. 63/738,900, filed on Dec. 26, 2024.

(51) Int. Cl. G06F 3/06

(52) U.S. Cl. CPC G06F 3/0631; G06F 3/0617; G06F 3/0673

(57) ABSTRACT

An electronic device is provided. The electronic device includes a memory and a compression engine. The compression engine is configured to reclaim pages of the memory. The compression engine receives a plurality of reclaim requests corresponding to a plurality of reclaim queues. The plurality of reclaim requests are assigned to the plurality of queues based on types of the plurality of reclaim requests.

### CROSS REFERENCE TO RELATED APPLICATIONS

This application claims priority of U.S. Provisional Application Ser. No. 63/738,900, filed on 2024 Dec. 26, the entirety of which is incorporated by reference herein.

### TECHNICAL FIELD

The present disclosure relates to memory management, and, in particular, to managing the reclaim of the memory.

### BACKGROUND

When the number of available memory pages is too low, the system may be stall or crushed. Thus, keeping a sufficient number of available memory pages is crucial for the system stability. The system may generate reclaim requests for reclaiming the used memory page, so as to increase the number of the available memory page. However, in the current memory reclaim mechanism, every reclaim requests are processed with the same priority, leading to the urgent requests not being processed immediately. This may result in memory reclamation that is not fast enough, and thus the number of available memory pages becomes too low.

Thus, current memory reclaim mechanism still has room for improvement.

### BRIEF SUMMARY

An embodiment of the present disclosure provides an electronic device. The electronic device comprises a memory and a compression engine. The compression engine is configured to reclaim pages of the memory. The compression engine receives a plurality of reclaim requests corresponding to a plurality of reclaim queues. The plurality of reclaim requests are assigned to the plurality of queues based on types of the plurality of reclaim requests.

An embodiment of the present disclosure provides a method for managing memory. The method comprises following operations. The compression engine reclaims pages of a memory. The compression engine receives a plurality of reclaim requests corresponding to a plurality of reclaim queues. The plurality of reclaim requests are assigned to the plurality of queues based on types of the plurality of reclaim requests.

### BRIEF DESCRIPTION OF THE DRAWINGS

The present disclosure can be more fully understood by reading the subsequent detailed description and examples with references made to the accompanying drawings, wherein:

FIG. 1 is a block diagram of the electronic device in accordance with embodiments of the present disclosure;

FIG. 2 is a block diagram of the electronic device in accordance with embodiments of the present disclosure;

FIGS. 3A and 3B are illustration diagrams in accordance with embodiments of the present disclosure; and

FIG. 4 is a flow diagram of the method for managing memory in accordance with embodiments of the present disclosure

### DETAILED DESCRIPTION

The following description is made for the purpose of illustrating the general principles of the disclosure and should not be taken in a limiting sense. The scope of the disclosure is best determined by reference to the appended claims.

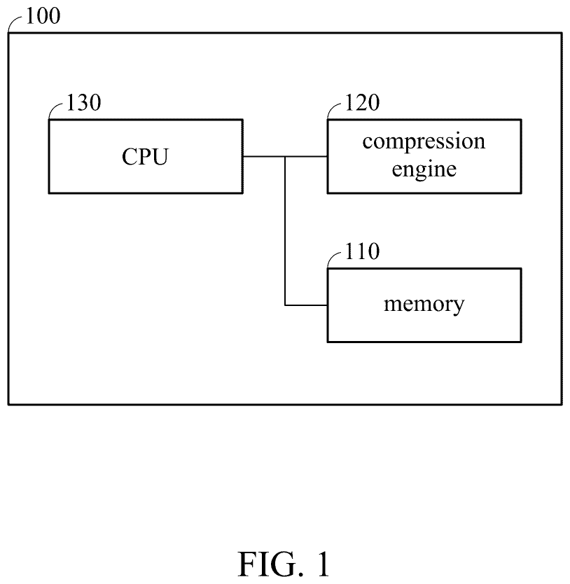

FIG. 1 is a block diagram of the electronic device 100 in accordance with embodiments of the present disclosure. The electronic device 100 comprises a memory 110, a compression engine 120, and a central processing unit (CPU) 130. The electronic device 100 may perform various functions to implement processes and methods described herein. For example, the electronic device 100 may be a computing device, a mobile device, a wearable device, an Internet-of-thing device, a computer, a smartphone, a smart watch, a tablet computer, a notebook computer, or a desktop computer.

In some embodiments, the memory 110 comprises a dynamic random-access memory (DRAM). The memory 110 may further comprise read only memory (ROM), flash memory, hard disk drive, and solid-state disk, static random-access memory (SRAM), or cache. The memory is configured to store data required by the CPU 130 and other components in the electronic device 100. The memory 110 may be divided into multiple (physical, or in some embodiments, logical) memory pages (also referred to as page in the following). When the page has already stored data in it, the memory page is unavailable. When the number of available memory pages is too low, the electronic device 100 may be stall or crushed.

The compression engine 120 is configured to reclaim pages of the memory 110. Specifically, the compression engine 120 is a hardware component configured to compress data stored in the memory page to be reclaimed. The compression engine 120 may then move the compressed data to another location in the memory 120. By compressing and moving the data in the memory page, the memory page is freed, allowing the memory page to be used. Thus, the memory page is “reclaimed”, and the number of available (or free) memory page is increased. In some embodiments, the compression engine may be implemented with one or more processors, such as processing circuit, a general-purpose processor, an application-specific integrated circuit, a micro-processor, a controller, a reduced-instruction set computing (RISC) processor, a complex-instruction-set-computing (CISC) processor, or any integrated circuit chip which is capable to read, write, and compress the data stored in memory 110.

The CPU 130 provides the required process and calculation capability to perform programs, software, modules, applications, operating systems, and functions. In some embodiments, the CPU 130 may be implemented in the form of hardware with electronic components, such as transistors, diodes, capacitors, resistors, or inductors.

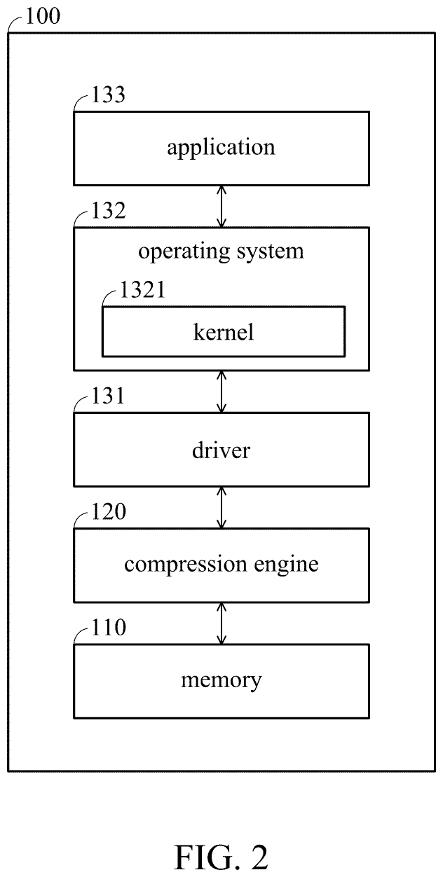

Refer to FIG. 2. FIG. 2 is a block diagram of the electronic device 100 in accordance with embodiments of the present disclosure. In some embodiments, the CPU 130 is configured to read and execute program stored in the memory 110 to implement driver 131, operating system (OS) 132, and application 133. In other words, the driver 131, the OS 132, and the application 133 are software modules or functions implemented by the CPU 130. In some embodiments, the driver 131, the OS 132, and the application 133 may generate reclaim requests. The reclaim request indicates the compression engine 120 to reclaim the memory.

The application 133 may be any type of application, such as a game application, a video and audio application, a web browser, an office application, or other types of applications. The application 133 may generate the reclaim request, and the reclaim request is transferred to the compression engine 120.

The OS 132 may comprise kernel 1321. Kernel 1321 is the layer to handle memory allocation requests and reclaim requests from application 133 and send reclaim requests to driver 131. When the number of free memory page of the memory 120 is insufficient, the kernel 1321 may also generate the reclaim request. The reclaim request may come from any thread or process executed on CPU 130. In some embodiments, the reclaim request is generated by a kswapd process. In some embodiments, the reclaim request is generated by other threads or process of the application 133.

The driver 131 is configured to manage Read and Write requests from a kernel 1321. The driver 131 is also configured to forward the reclaim request received from the kernel 1321 to the compression engine 120. In the current memory reclaim mechanism, the compression engine 120 only provides one queue to receive the reclaim requests, and only one source (e.g. the thread, the process, the application 133, or the OS 132) can add the reclaim request into the queue at a time. Thus, the compression engine 120 processes the reclaim requests from all the sources with the same priority. As a result, the urgent requests are not processed immediately, and memory reclamation is not fast enough. Therefore, the number of available memory pages may become too low to maintain the smooth operation of the electronic device 100.

In the proposed embodiments, the compression engine 120 receives reclaim requests corresponding to queues. The reclaim requests are assigned to the queues based on types of the reclaim requests. In other words, the compression engine 120 provides multiple queues. Each of the queues corresponds to one type of the reclaim requests. One reclaim request is assigned to the corresponding queue based on the type of the reclaim request. Each of the queues is configured to receive and store the corresponding type of reclaim requests. Furthermore, the compression engine 120 is configured to provide the queues and process the reclaim requests stored in the different queues according to the priorities of the queues. The compression engine 120 determines that the different types of the reclaim requests in different queues have different priority and processes the reclaim requests in order of priority.

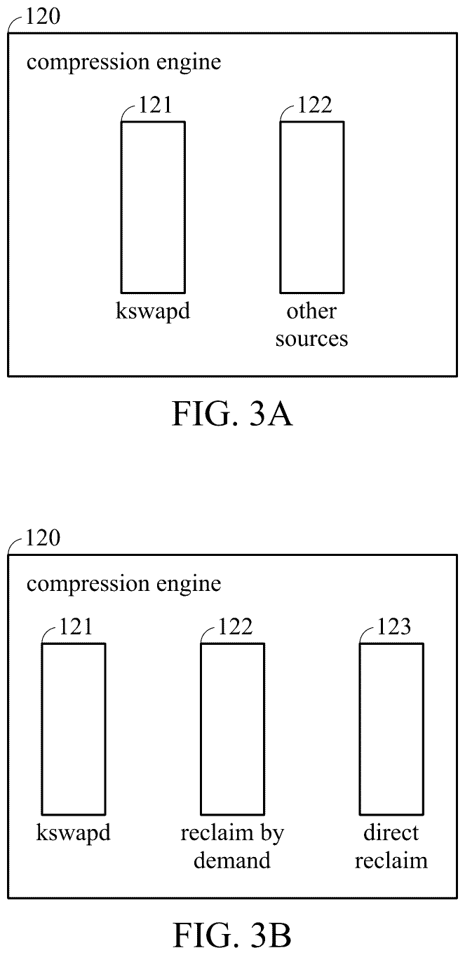

Refer to FIG. 3. FIG. 3 is an illustration diagram in accordance with embodiments of the present disclosure. As shown in part (a) of FIG. 3, in some embodiments, the queues in the compression engine 120 comprises the first queue 121 and the second queue 122. The first queue 121 is configured to store reclaim requests from the kswapd process. The second queue 122 is configured to store reclaim requests from sources other than the kswapd process, such as the application 133, the OS 132, the kernel 1321, or processes other than the kswapd process. The compression engine 120 is configured to process the reclaim requests stored in the first queue 121 with the highest priority. In other words, the compression engine 120 has a specialized queue dedicated to storing reclaim requests from the kswapd process, and the reclaim requests from the kswapd process are processed with the highest priority.

In some embodiments, the purpose of the reclaim requests stored in the first queue 121 is to avoid system stall (e.g. to avoid the electronic device 100 to stall or to crush). The purpose of the reclaim requests stored in the second queue 122 is not to avoid system stall.

The kswapd process is a process (or thread) of the kernel 1321. The kswapd process is configured to reclaim the memory, so as to keep the number of free pages higher than a predetermined threshold to ensure the electronic device 100 functions properly. If the number of free pages become lower than the predetermined threshold, the electronic device 100 may be stall or crushed. Because the kswapd process is a dedicated process to keep the number of free page sufficient to avoid system stall, the kswapd process will definitely reclaim the memory page enough to make the number of free pages become higher than the predetermined threshold. On the other hand, while other types of reclaim requests may also reclaim the memory page, these kind of reclaim requests may not necessarily free up enough memory page to make the number of free pages become higher than the predetermined threshold. Thus, providing a dedicated queue for the reclaim requests from the kswapd process and giving the reclaim requests from the kswapd process the highest priority can ensure there are sufficient free pages for the electronic device 100 to operate properly.

As shown in part (b) of FIG. 3, in the queues in the compression engine 120 comprises the first queue 121, the second queue 122, and the third queue 123. The first queue 121 is configured to store reclaim requests from a kswapd process. The second queue 122 is configured to store reclaim requests from the application 133. Specifically, the application 133 may generate commands proactively to reclaim the memory, for example, by a thread or process of the application 133 configured to optimize the operation of the application 133. The purpose of the reclaim requests stored in the second queue 122 is to reclaim pages but not to avoid system stall. Thus, these reclaim requests has priority lower than the reclaim requests generated by the kswapd process. This kind of reclaim requests may be referred to as “reclaim by demand”.

The third queue 123 is configured to store reclaim requests from the application 133 or the OS 132. The purpose of the reclaim requests stored in the third queue is to reclaim the pages of the memory occupied by a process that takes up large amounts of memory. Specifically, the application 133 or the OS 132 may generate reclaim requests for reclaiming the memory pages occupied by process that takes up large amounts of memory so as to throttle processes and avoid free pages drops too fast. The purpose of the reclaim requests stored in the third queue 123 is to reclaim pages but not to avoid system stall. Thus, these reclaim requests has priority lower than the reclaim requests generated by the kswapd process. This kind of reclaim requests may be referred to as “direct reclaim”.

In some embodiments, the compression engine 120 is configured to process the reclaim requests stored in the first queue 121 with the highest priority. The compression engine 120 may determine that the reclaim requests in the second queue 122 and the third queue 123 have the same priority.

Thus, in the embodiments of the present disclosure, the compression engine 120 provides multiple queues. The compression engine 120 receives and stores different types of reclaim requests in the different queues. Each of the queues corresponds to a type of the reclaim requests and is configured to receive and store the said type of the reclaim request. The reclaim requests from different sources (e.g. the kswapd process, the application 133, the OS 132, or the kernel 1321) may be identified to be different types. The reclaim requests having different purposes (e.g. to avoid system stall, not to avoid system stall, to optimize the operation of the application, or to throttle the process) may be identified to be different types. The compression engine 120 is configured to identify the types of the reclaim requests based on the sources and/or the purpose of the reclaim requests. The compression engine 120 is configured to assign the reclaim requests to the corresponding queue based on the type of the reclaim request. The compression engine 120 is configured to store the reclaim requests in the corresponding queue based on the type of the reclaim request. The compression engine 120 is then configured to process the reclaim requests based on the priority of the queues (i.e. the priority of the types of the reclaim requests). Thus, the urgent and important reclaim requests are processed first to avoid the electronic device 100 to stall or crushed.

It is noted that the queues in the compression engine 120 (such as the first queue 121, the second queue 122, and the third queue 123) may be implemented in hardware or software. In some embodiments, the first queue 121, the second queue 122, and the third queue 123 are data structures established in the storage device of the compression engine 120. These queues may be the software function provided by the compression engine 120. In other embodiments, the first queue 121, the second queue 122, and the third queue 123 are physically separated hardware components in the compression engine 120, such as buffers, registers, or memories.

Furthermore, the electronic device 100 may comprise components not shown in FIGS. 1 and 2. For example, the electronic device 100 may further comprise a graphics processing unit (GPU), a general-purpose micro-processor, an application processor, an, a digital signal processor, an internal power supply, an input/output device, a keyboard, a mouse, a speaker, or a touch screen.

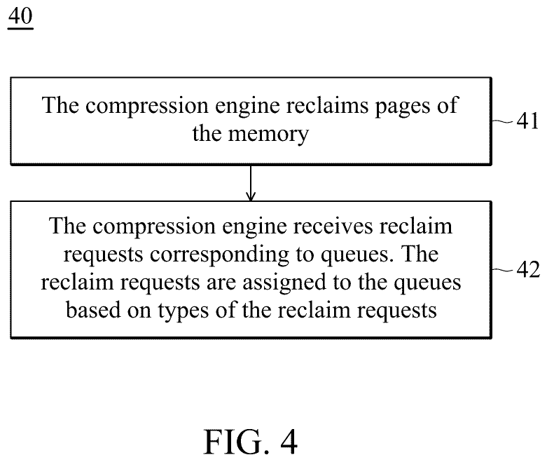

FIG. 4 is a flow diagram of the method 40 for managing memory in accordance with embodiments of the present disclosure. Method 40 may be implemented in the electronic device 100. In operation 41, the compression engine 120 reclaims pages of the memory 110. In operation 42, the compression engine 120 receives reclaim requests corresponding to queues. The reclaim requests are assigned to the queues based on types of the reclaim requests.

In some embodiments, the method 40 further comprises the following operation: the compression engine 120 provides the queues and processes the reclaim requests stored in the different queues according to the priorities of the queues. In some embodiments, the queues comprise the first queue 121 configured to store reclaim requests from a kswapd process. In some embodiments, the method 40 further comprises the following operation: the compression engine 120 processes the reclaim requests stored in the first queue 121 with the highest priority. In some embodiments, the second queue, configured to store reclaim requests from sources other than the kswapd process.

In some embodiments, the method 40 further comprises the following operation: the CPU 130 implements an application 133. The queues comprise the second queue 122 configured to store reclaim requests from the application 133.

In some embodiments, the method 40 further comprises the following operation:
the CPU 130 implements an application 133 or OS 132. The queues comprise the third queue 123 configured to store reclaim requests from the application 133 or the OS 132. In some embodiments, the purpose of the reclaim requests stored in the third queue is to reclaim the pages of the memory occupied by a process that takes up large amounts of memory.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, comprising:
a memory; and
a compression engine, configured to reclaim pages of the memory;
wherein the compression engine receives a plurality of reclaim requests corresponding to a plurality of queues, wherein the plurality of reclaim requests are assigned to the plurality of queues based on types of the plurality of reclaim requests.

2. The electronic device as claimed in claim 1, wherein the compression engine provides the plurality of queues and is configured to process the plurality of reclaim requests stored in different queues according to priorities of the plurality of queues.

3. The electronic device as claimed in claim 1, wherein the plurality of queues comprise a first queue configured to store reclaim requests from a kswapd process.

4. The electronic device as claimed in claim 3, wherein the compression engine is configured to process the reclaim requests stored in the first queue with the highest priority.

5. The electronic device as claimed in claim 3, wherein the plurality of queues comprise a second queue, configured to store reclaim requests from sources other than the kswapd process.

6. The electronic device as claimed in claim 1, further comprising a central processing unit (CPU), configured to implement an application;
wherein the plurality of queues comprise a second queue configured to store reclaim requests from the application.

7. The electronic device as claimed in claim 1, further comprising a central processing unit (CPU), configured to implement an application and an operating system (OS);
wherein the plurality of queues comprise a third queue configured to store reclaim requests from the application or the OS.

8. The electronic device as claimed in claim 7, wherein the purpose of the plurality of reclaim requests stored in the third queue is to reclaim the pages of the memory occupied by a process that takes up large amounts of memory.

9. A method for managing memory, comprising:
reclaiming, via a compression engine, pages of a memory; and
receiving, via the compression engine, a plurality of reclaim requests corresponding to a plurality of reclaim queues, wherein the plurality of reclaim requests are assigned to the plurality of queues based on types of the plurality of reclaim requests.

10. The method as claimed in claim 9, further comprising:
providing, via the compression engine, the plurality of queues; and
processing, via the compression engine, the plurality of reclaim requests stored in the different queues according to priorities of the plurality of queues.

11. The method as claimed in claim 9, wherein the plurality of queues comprise a first queue configured to store reclaim requests from a kswapd process.

12. The method as claimed in claim 11, further comprising:
processing, via the compression engine, the plurality of reclaim requests stored in the first queue with the highest priority.

13. The method as claimed in claim 11, wherein the plurality of queues comprise a second queue, configured to store reclaim requests from sources other than the kswapd process.

14. The method as claimed in claim 9, further comprising:
implementing, via a central processing unit (CPU), an application;
wherein the plurality of queues comprise a second queue configured to store reclaim requests from the application.

15. The method as claimed in claim 9, further comprising:
implementing, via a central processing unit (CPU), an application and an operating system (OS);
wherein the plurality of queues comprise a third queue configured to store reclaim requests from the application or the OS.

16. The method as claimed in claim 15, wherein the purpose of the plurality of reclaim requests stored in the third queue is to reclaim the pages of the memory occupied by a process that consumes large amounts of memory.
